(19) United States
(12) Patent Application Publication
(10) Pub. No.: US 2026/0147158 A1
(43) Pub. Date: May 28, 2026

(54) COMMUNICATION SYSTEM

(71) Applicant: FUJIFILM Corporation, Tokyo (JP)

(72) Inventor: Yujiro YANAI, Minamiashigara-shi (JP)

(73) Assignee: FUJIFILM Corporation, Tokyo (JP)

(21) Appl. No.: 19/450,575

(22) Filed: Jan. 15, 2026

Related U.S. Application Data
(63) Continuation of application No. PCT/JP2024/024706, filed on Jul. 9, 2024.

(30) Foreign Application Priority Data
Jul. 19, 2023 (JP) 2023-117446
Oct. 26, 2023 (JP) 2023-183877

(51) Int. Cl. G02B 6/26

(52) U.S. Cl. CPC G02B 6/262

(57) ABSTRACT

Provided is a method of suppressing an output light intensity difference caused by inter-core crosstalk in order to reduce signal processing of a coupled MCF as much as possible. A communication system includes a coupled multi-core fiber, input-side single-mode fibers and output-side single-mode fibers corresponding to the number of cores of the coupled multi-core fiber, a fan-in element that connects the input-side single-mode fibers and the coupled multi-core fiber, a fan-out element that connects the coupled multi-core fiber and the output-side single-mode fibers, and an optical element, and the optical element is an element that is disposed between the input-side single-mode fibers and the fan-in element or between the fan-in element and the coupled multi-core fiber, and changes any one of polarization or phase of incident light, or both.

### CROSS-REFERENCE TO RELATED APPLICATIONS

This application is a Continuation of PCT International Application No. PCT/JP2024/024706 filed on Jul. 9, 2024, which claims priority under 35 U.S.C. § 119(a) to Japanese Patent Application No. 2023-117446 filed on Jul. 19, 2023 and Japanese Patent Application No. 2023-183877 filed on Oct. 26, 2023. The above applications are hereby expressly incorporated by reference, in their entirety, into the present application.

### BACKGROUND OF THE INVENTION

### 1. Field of the Invention

The present invention relates to a communication system, and particularly to a reduction in a load of signal processing in a coupled multi-core fiber capable of high-capacity communication.

### 2. Description of the Related Art

In recent years, in the information society, the volume of data communication has rapidly increased with the development of communication equipment. In addition, as referred to as 5G (Generation) and 6G, not only an increase in the communication volume but also low latency, multiple connections to terminal devices such as smartphones are becoming possible, and the widespread use of artificial intelligence (AI) is becoming more common. Therefore, the volume of data communication is expected to continue to increase in the future.

In high-capacity communication, even in a wavelength division multiplexing method (transmission of light of different wavelengths through one optical fiber) that is currently mainstream, a technology for high capacity has been developed. However, the number of wavelengths available for use in the wavelength multiplexing method is limited, and it is highly likely that it cannot cope with a rapid increase in communication capacity expected in the future.

In the related art, in order to increase a transmission capacity per optical fiber, research and development of a multi-core fiber (MCF) having a plurality of cores in one fiber have been carried out.

The MCF includes an uncoupled MCF that is an optical fiber in which a distance between cores is increased to suppress inter-core crosstalk and a coupled MCF that is an optical fiber having a high core density by reducing the distance between cores.

In the uncoupled MCF, each core is an independent optical transmission path, so that transmission technology and signal processing technology developed in optical communication developed to date can be used as they are.

On the other hand, the coupled MCF is an optical fiber having a high core density by reducing a core interval, but crosstalk occurs between the cores, so that it is necessary to receive an optical signal in consideration of the crosstalk, and signal processing by a digital signal processor (DSP) or the like is required.

JP2020-171103A proposes a method of stably controlling an optical amplifier in a coupled MCF.

### SUMMARY OF THE INVENTION

The signal processing of the coupled MCF requires more complicated processing as compared with the signal processing in the related art or the signal processing of the uncoupled MCF, and as a result, it is likely to cause a factor that delays practical use due to increased complexity of signal circuits and an increase in power consumption.

In view of the above, an object of the present invention is to provide a method of suppressing an output light intensity difference caused by inter-core crosstalk in order to reduce signal processing of the coupled MCF as much as possible.

In order to achieve the object, the present invention has the following configurations.

[1] A communication system comprising: a coupled multi-core fiber, input-side single-mode fibers and output-side single-mode fibers corresponding to the number of cores of the coupled multi-core fiber, a fan-in element that connects the input-side single-mode fibers and the coupled multi-core fiber, a fan-out element that connects the coupled multi-core fiber and the output-side single-mode fibers, and an optical element, in which the optical element is an element that is disposed between the input-side single-mode fibers and the fan-in element or between the fan-in element and the coupled multi-core fiber, and changes any one of polarization or phase of incident light, or both.

[2] The communication system according to [1], in which the optical element is a patterned phase difference element that has two or more slow axis directions in a plane, and light of each core after passing through the optical element is P-polarized light or S-polarized light.

[3] The communication system according to [1], in which the optical element is an optical element that includes a patterned phase difference element having two or more slow axis directions in a plane and a polarizing plate, and light of each core after passing through the optical element is P-polarized light or S-polarized light.

[4] The communication system according to [1], in which the optical element is a patterned polarizing plate that has two or more transmission axes in a plane, and light of each core after passing through the optical element is P-polarized light or S-polarized light.

[5] The communication system according to [1], in which phase of light of each core after passing through the optical element satisfies (phase of light before passing through the optical element)−20 degrees≤(phase of light after passing through the optical element)≤(phase of light before passing through the optical element)+20 degrees or (phase of light before passing through the optical element)+160 degrees≤(phase of light after passing through the optical element)≤(phase of light before passing through the optical element)+200 degrees.

[6] The communication system according to [1], further comprising: another optical element that is disposed between the coupled multi-core fiber and the fan-out element or between the fan-out element and the output-side single-mode fibers, in which the other optical element changes an intensity of emitted light.

[7] The communication system according to [1], in which the other optical element is an optical element that includes a patterned phase difference element having two or more slow axis directions in a plane and a polarizing plate, and a difference in light intensity among the cores after passing through the other optical element is within ±10%.

[8] The communication system according to [1], in which the other optical element is a patterned polarizing plate that has two or more transmission axes in a plane, and a difference in light intensity among the cores after passing through the other optical element is within ±10%.

[9] A communication system comprising: a coupled multi-core fiber, input-side single-mode fibers and output-side single-mode fibers corresponding to the number of cores of the coupled multi-core fiber, a fan-in element that connects the input-side single-mode fibers and the coupled multi-core fiber, a fan-out element that connects the coupled multi-core fiber and the output-side single-mode fibers, and an optical element, in which the optical element is an element that is disposed between the coupled multi-core fiber and the fan-out element or between the fan-out element and the output-side single-mode fibers, and changes an intensity of emitted light.

[10] The communication system according to [9], in which the optical element is an optical element that includes a patterned phase difference element having two or more slow axis directions in a plane and a polarizing plate, and a difference in light intensity among the cores after passing through the optical element is within ±10%.

[11] The communication system according to [9], in which the optical element is a patterned polarizing plate that has two or more transmission axes in a plane, and a difference in light intensity among the cores after passing through the optical element is within ±10%.

[12] The communication system according to any one of [1] to [11], in which the fan-in element or the fan-out element, or both are elements including a liquid crystal diffraction element or a liquid crystal lens element, or both.

According to the present invention, an output light intensity difference caused by inter-core crosstalk in the coupled MCF can be suppressed.

### BRIEF DESCRIPTION OF THE DRAWINGS

FIG. 1 is a schematic diagram showing a first example of a communication system using a coupled MCF having four cores in which an optical element according to the present invention is disposed.

FIG. 2 is a schematic diagram showing an example of a patterned phase difference of the optical element, in which an arrow direction represents a slow axis direction.

FIG. 3 is a schematic diagram showing an example of a patterned phase difference of the optical element, in which an arrow direction represents a slow axis direction.

FIG. 4 is a schematic diagram showing an example of a patterned polarizing plate of the optical element, in which an arrow direction represents a transmission axis direction.

FIG. 5 is a schematic diagram showing a second example of a communication system using a coupled MCF having four cores in which an optical element according to the present invention is disposed.

FIG. 6 is a schematic diagram showing a third example of a communication system using a coupled MCF having four cores in which an optical element according to the present invention is disposed.

### DESCRIPTION OF THE PREFERRED EMBODIMENTS

Hereinafter, a suitable embodiment of the communication system according to the embodiment of the present invention will be described in detail.

In the present specification, numerical ranges represented by “to” include numerical values before and after “to” as lower limit values and upper limit values.

In addition, a particular angle includes a range of errors generally acceptable in the corresponding technical field unless particularly stated otherwise.

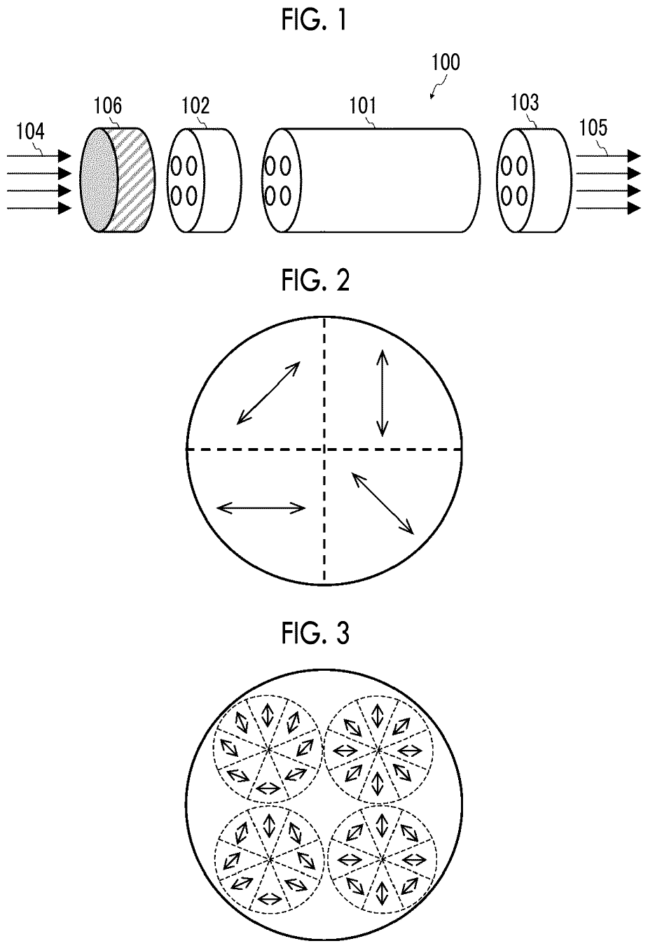

FIG. 1 is a schematic diagram showing a first example of a communication system using a coupled MCF having four cores in which an optical element according to the present invention is disposed. In a communication system 100, a coupled multi-core fiber 101 (hereinafter, referred to as a coupled MCF 101) is connected to input-side single-mode fibers 104 and output-side single-mode fibers 105 via a fan-in element 102 and a fan-out element 103. An optical element 106 is disposed between the input-side single-mode fibers 104 and the fan-in element 102.

FIG. 1 is an example of the disposition of the optical element 106. As described above, the optical element 106 is disposed between the input-side single-mode fibers 104 and the fan-in element 102, but the optical element 106 may be disposed between the fan-in element 102 and the coupled MCF 101.

From the viewpoint of suppressing crosstalk, it is preferable that, regarding light after passing through the optical element 106, light of one core is P-polarized light and light of the other cores is S-polarized light.

In a case of an MCF having three or more cores, it is preferable that a polarization state of one core 1 and a core 2 that is closest to the one core 1 is P-polarized light and S-polarized light, and it is preferable that light of a next adjacent core 3 has a polarization state different from a polarization state of light of a core closest to the core 3.

In a case of a large number of cores, P-polarized light may be adjacent to P-polarized light or S-polarized light may be adjacent to S-polarized light depending on the disposition or the distance, but it is desirable to control the polarization such that P-polarized light is not adjacent to P-polarized light and S-polarized light is not adjacent to S-polarized light as much as possible.

In addition, from the viewpoint of suppressing crosstalk, it is preferable that, regarding light after passing through the optical element 106, the phase of light of the other cores is shifted by 180 degrees relative to the light of one core.

In a case of an MCF having three or more cores, it is preferable that the phase is shifted by 180 degrees relative to the closest adjacent core as described above. Even in a case of a large number of cores, it is desirable to control the polarization such that P-polarized light is not adjacent to P-polarized light and S-polarized light is not adjacent to S-polarized light as much as possible as described above.

For example, in a case of FIG. 1 where the number of cores is four, adjacent cores have phases shifted by 180 degrees, and cores positioned on a diagonal line can have the same phase. A phase shift in the case of making the phases the same may be within 40 degrees, but is preferably within 20 degrees and more preferably within 10 degrees.

In addition, a phase shift between adjacent cores may be within 160 degrees to 200 degrees, but is preferably within a range of 170 degrees to 190 degrees and more preferably within a range of 175 degrees to 185 degrees.

In addition, it is preferable that phase of light of each core after passing through the optical element is (phase of light before passing through the optical element)−20 degrees≤(phase of light after passing through the optical element)≤(phase of light before passing through the optical element)+20 degrees or (phase of light before passing through the optical element)+160 degrees≤(phase of light after passing through the optical element)≤(phase of light before passing through the optical element)+200 degrees.

The optical element 106 may be appropriately selected from a patterned phase difference element, a combination of a patterned phase difference and a polarizing plate, or a patterned polarizing plate, according to a polarization state of incident light.

The patterned phase difference element is a phase difference element having two or more slow axis directions in a plane, and may be formed by bonding phase difference elements such that slow axis directions are different, or may be formed by, for example, a method of performing rubbing a plurality of times in different directions or a method of disposing a refractive index anisotropic material after irradiating a photo-alignment film with polarized ultraviolet (UV) a plurality of times in different directions, but from the viewpoint of avoiding adverse effects due to a boundary portion and the viewpoint of productivity, the latter methods are preferable.

In addition, in the latter case, examples of the refractive index anisotropic material include a liquid crystal compound.

FIGS. 2 and 3 show schematic diagrams showing examples of the patterned phase difference element. An arrow direction represents a slow axis direction.

In addition, the patterned polarizing plate is a polarizing plate having two or more transmission axis directions in a plane, and may be formed by bonding polarizing plates such that transmission axis directions are different, or may be formed by, for example, a method of changing a direction of a wire grid polarizing plate, a method of performing rubbing a plurality of times in different directions, or a method of disposing a dichroic coloring agent or the like after irradiating a photo-alignment film with polarized UV a plurality of times in different directions. From the viewpoint of avoiding adverse effects due to a boundary portion and the viewpoint of productivity, the latter methods are preferable.

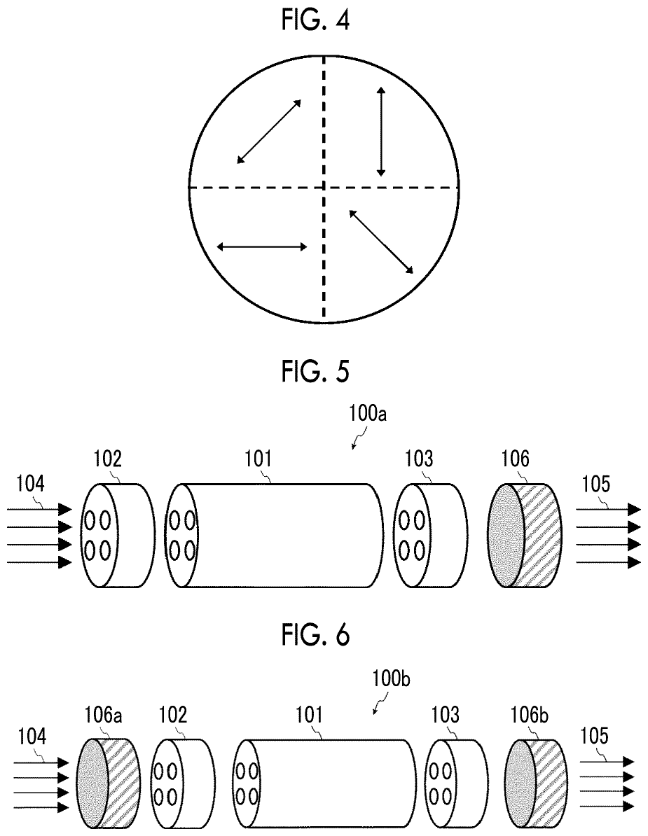

FIG. 4 shows a schematic diagram showing an example of the patterned polarizing plate. An arrow direction represents a transmission axis direction.

FIG. 5 is a schematic diagram showing a second example of a communication system using a coupled MCF having four cores in which an optical element according to the present invention is disposed. In FIG. 5, the same components as those of the communication system 100 shown in FIG. 1 are designated by the same reference numerals, and detailed description thereof will be omitted.

A communication system 100a shown in FIG. 5 is configured in the same manner as the communication system 100 shown in FIG. 1, except that a disposition position of the optical element 106 is different from that of the communication system 100 shown in FIG. 1. The optical element 106 is disposed between the fan-out element 103 and the output-side single-mode fibers 105.

FIG. 5 is an example of the disposition of the optical element 106. As described above, the optical element 106 is disposed between the fan-out element 103 and the output-side single-mode fibers 105, but the optical element 106 may be disposed between the coupled MCF 101 and the fan-out element 103.

From the viewpoint of reducing a load of signal processing, it is preferable that, regarding the light after passing through the optical element 106, a difference in light intensity among the cores is within ±10%.

For example, by making a difference in light intensity within ±10%, a proportion of crosstalk of each core can be kept constant, so that it is easy to detect a main component by signal processing or to set an intensity of light of a laser for amplification.

In addition, from the viewpoint of reducing the load of signal processing, it is more preferable that, regarding light after passing through the optical element 106, polarization of crosstalk light of each core is shielded and the difference in light intensity is within ±10%.

As a result, since the crosstalk of each core itself can be reduced, it is further easy to detect the main component by signal processing or to set the intensity of light of the laser for amplification.

In this case, the optical element 106 may be appropriately selected from a combination of a patterned phase difference element and a polarizing plate, or a patterned polarizing plate, according to a polarization state of emitted light.

The patterned phase difference element and the patterned polarizing plate may be the same as those described above.

In addition, it is preferable that the fan-in element or the fan-out element, or both are elements including a liquid crystal diffraction element or a liquid crystal lens element, or both.

As described above, the fan-in element and the fan-out element are elements for connecting the multi-core fiber and the single-mode fibers.

As the connection method, there are a space-coupling type using an optical refraction element such as a prism or a normal lens, a fiber bundle type in which fiber cores are bonded to each other, and the like. In these methods, a connection loss occurs due to a misalignment of each fiber core. In addition, since a loss amount changes depending on the amount of misalignment, it is a factor of the output light intensity difference. This suppression requires position control of each core; however, since the paths of the cores are handled by a single refractive element and a misalignment of one core affects the misalignment of the other cores, the control is very difficult.

In addition, as another connection method, there is an optical waveguide type, but a connection loss occurs due to a mode loss caused by a shape difference between an optical fiber core and a waveguide or by a bending loss that occurs at a bent portion of the waveguide, so that it may be a factor of the output light intensity difference.

On the other hand, for example, by designing to match each core using the liquid crystal diffraction element, such as patterning liquid crystal diffraction elements having different diffraction directions at different positions in a plane, it is possible to independently control light passing through each core. In addition, since a diffraction efficiency can be increased, a loss corresponding to the bending loss of the optical waveguide can be reduced. In addition, since there is no surface unevenness, bonding between the cores is also possible, and an interface loss can be suppressed. As a result, a connection loss between the cores can be reduced, and the output light intensity difference can be suppressed.

Since a loss difference on the incidence side may lead to a loss difference on the output side, the element can also be applied to the fan-in element. In addition, it is also possible to apply the element to both the fan-in element and the fan-out element.

FIG. 6 is a schematic diagram showing a third example of a communication system using a coupled MCF having four cores in which an optical element according to the present invention is disposed. In FIG. 6, the same components as those of the communication system 100 shown in FIG. 1 are assigned with the same reference numerals, and detailed description thereof will be omitted.

A communication system 100b shown in FIG. 6 is configured in the same manner as the communication system 100 shown in FIG. 1, except that the communication system 100b differs in that, in addition to the optical element 106a, it has another optical element 106b as compared with the communication system 100 shown in FIG. 1. The communication system 100b has a configuration in which the communication system 100 shown in FIG. 1 and the communication system 100a shown in FIG. 5 are combined.

In the communication system 100b, the optical element 106a is disposed between the input-side single-mode fibers 104 and the fan-in element 102. The other optical element 106b is disposed between the fan-out element 103 and the output-side single-mode fibers 105.

In the communication system 100b shown in FIG. 6, as described above, the optical element 106a may be disposed between the coupled MCF 101 and the fan-out element 103, or the other optical element 106b may be disposed between the coupled MCF 101 and the fan-out element 103.

Although representative embodiments of the present invention have been described above, the present invention is not limited to the above unless it is within the scope of the claims, and various aspects that can be understood by those skilled in the art can be applied.

### EXPLANATION OF REFERENCES

100, 100a, 100b: communication system
101: coupled multi-core fiber
102: fan-in element
103: fan-out element
104: input-side single-mode fiber
105: output-side single-mode fiber
106, 106a: optical element
106b: another optical element

What is claimed is:

1. A communication system comprising:
a coupled multi-core fiber;
input-side single-mode fibers and output-side single-mode fibers corresponding to the number of cores of the coupled multi-core fiber;
a fan-in element that connects the input-side single-mode fibers and the coupled multi-core fiber;
a fan-out element that connects the coupled multi-core fiber and the output-side single-mode fibers; and
an optical element,
wherein the optical element is an element that is disposed between the input-side single-mode fibers and the fan-in element or between the fan-in element and the coupled multi-core fiber, and changes any one of polarization or phase of incident light, or both.

2. The communication system according to claim 1,
wherein the optical element is a patterned phase difference element that has two or more slow axis directions in a plane, and
light of each core after passing through the optical element is P-polarized light or S-polarized light.

3. The communication system according to claim 1,
wherein the optical element is an optical element that includes a patterned phase difference element having two or more slow axis directions in a plane and a polarizing plate, and
light of each core after passing through the optical element is P-polarized light or S-polarized light.

4. The communication system according to claim 1,
wherein the optical element is a patterned polarizing plate that has two or more transmission axes in a plane, and
light of each core after passing through the optical element is P-polarized light or S-polarized light.

5. The communication system according to claim 1,
wherein phase of light of each core after passing through the optical element satisfies
(phase of light before passing through the optical element)−20 degrees≤(phase of light after passing through the optical element)≤(phase of light before passing through the optical element)+20 degrees or
(phase of light before passing through the optical element)+160 degrees≤(phase of light after passing through the optical element)≤(phase of light before passing through the optical element)+200 degrees.

6. The communication system according to claim 1, further comprising:
another optical element that is disposed between the coupled multi-core fiber and the fan-out element or between the fan-out element and the output-side single-mode fibers,
wherein the other optical element changes an intensity of emitted light.

7. The communication system according to claim 6,
wherein the other optical element is an optical element that includes a patterned phase difference element having two or more slow axis directions in a plane and a polarizing plate, and
a difference in light intensity among the cores after passing through the other optical element is within ±10%.

8. The communication system according to claim 6,
wherein the other optical element is a patterned polarizing plate that has two or more transmission axes in a plane, and
a difference in light intensity among the cores after passing through the other optical element is within ±10%.

9. A communication system comprising:
a coupled multi-core fiber;
input-side single-mode fibers and output-side single-mode fibers corresponding to the number of cores of the coupled multi-core fiber;
a fan-in element that connects the input-side single-mode fibers and the coupled multi-core fiber;
a fan-out element that connects the coupled multi-core fiber and the output-side single-mode fibers; and
an optical element,
wherein the optical element is an element that is disposed between the coupled multi-core fiber and the fan-out element or between the fan-out element and the output-side single-mode fibers, and changes an intensity of emitted light.

10. The communication system according to claim 9,
wherein the optical element is an optical element that includes a patterned phase difference element having two or more slow axis directions in a plane and a polarizing plate, and
a difference in light intensity among the cores after passing through the optical element is within ±10%.

11. The communication system according to claim 9,
wherein the optical element is a patterned polarizing plate that has two or more transmission axes in a plane, and
a difference in light intensity among the cores after passing through the optical element is within ±10%.

12. The communication system according to claim 1,
wherein the fan-in element or the fan-out element, or both are elements including a liquid crystal diffraction element or a liquid crystal lens element, or both.

13. The communication system according to claim 2,
wherein the fan-in element or the fan-out element, or both are elements including a liquid crystal diffraction element or a liquid crystal lens element, or both.

14. The communication system according to claim 3,
wherein the fan-in element or the fan-out element, or both are elements including a liquid crystal diffraction element or a liquid crystal lens element, or both.

15. The communication system according to claim 4,
wherein the fan-in element or the fan-out element, or both are elements including a liquid crystal diffraction element or a liquid crystal lens element, or both.

16. The communication system according to claim 5,
wherein the fan-in element or the fan-out element, or both are elements including a liquid crystal diffraction element or a liquid crystal lens element, or both.

17. The communication system according to claim 6,
wherein the fan-in element or the fan-out element, or both are elements including a liquid crystal diffraction element or a liquid crystal lens element, or both.

18. The communication system according to claim 7,
wherein the fan-in element or the fan-out element, or both are elements including a liquid crystal diffraction element or a liquid crystal lens element, or both.

19. The communication system according to claim 8,
wherein the fan-in element or the fan-out element, or both are elements including a liquid crystal diffraction element or a liquid crystal lens element, or both.

20. The communication system according to claim 9,
wherein the fan-in element or the fan-out element, or both are elements including a liquid crystal diffraction element or a liquid crystal lens element, or both.
